(19) United States
(12) Patent Application Publication
(10) Pub. No.: US 2026/0331406 A1
(43) Pub. Date: Oct. 22, 2026

(54) CIRCUIT PROTECTION UNIT AND CONDUCTIVE MODULE

(71) Applicant: YAZAKI CORPORATION, Tokyo (JP)

(72) Inventors: Miho Suzuki, Makinohara-shi (JP); Katsunori Sato, Makinohara-shi (JP); Yasuhiro Kominato, Makinohara-shi (JP); Mariko Nakagawa, Makinohara-shi (JP); Kota Morishige, Makinohara-shi (JP)

(21) Appl. No.: 19/648,370

(22) Filed: Apr. 15, 2026

(30) Foreign Application Priority Data
Apr. 17, 2025 (JP) 2025-067873

(51) Int. Cl. H01H 85/02; H01H 85/175; H01H 85/18; H01H 85/20; H01M 10/42; H01M 50/503; H01M 50/583

(52) U.S. Cl. CPC H01H 85/0241; H01H 85/175; H01H 85/18; H01H 85/2045; H01M 10/425; H01M 50/503; H01M 50/583; H01H 2085/025; H01M 2010/4271

(57) ABSTRACT

A circuit protection unit to be applied to a conductive module includes: a circuit protection component; a first terminal fitting that electrically connects a first electric connection portion to the circuit protection component; a second terminal fitting that electrically connects a second electric connection portion to the circuit protection component; and a housing component that has insulation property and internally houses the first electric connection portion, the second electric connection portion, and the circuit protection component. The housing component includes a bottom wall portion; a plurality of side wall portions protruding from the bottom wall portion and provided at positions surrounding the first electric connection portion, the second electric connection portion, and the circuit protection component as viewed from a plate thickness direction (height direction); and a side wall opening opened toward a direction intersecting with the plate thickness direction.

### CROSS-REFERENCE TO RELATED APPLICATIONS

The present application claims priority to and incorporates by reference the entire contents of Japanese Patent Application No. 2025-067873 filed in Japan on Apr. 17, 2025.

### BACKGROUND OF THE INVENTION

### 1. Field of the Invention

The present invention relates to a circuit protection unit and a conductive module.

### 2. Description of the Related Art

A conductive module electrically connects a plurality of battery cells by using a plurality of connection conductors in a battery module in which the plurality of battery cells is aligned. Then, the conductive module electrically connects the connection conductors to a battery monitoring unit that monitors the battery states of the battery cells by using wiring components such as electric wires. For example, Japanese Patent Application Laid-open No. JP 2020 - 119 651 A discloses this type of conductive module. In such a conductive module, a combination of a connection conductor and a conductor portion of a wiring component to be paired is provided for each connection conductor. A circuit protection component such as a fuse may be interposed between the connection conductor and the conductor portion of the wiring component in each combination. For example, Japanese Patent No. JP 7 561 318 B1 discloses a circuit protection unit (including chip fuse, pair of terminal fittings, and resin portion) to be applied to the conductive module.

Incidentally, a conventional circuit protection unit surrounds connection portions between a circuit protection component and a pair of terminal fittings with a frame-shaped resin portion. In this case, however, it may cost excessively, or the heat may accumulate inside the resin portion. Therefore, such a circuit protection unit has room for further improvement in a structure for protecting connection portions between a circuit protection component and a pair of terminal fittings.

### SUMMARY OF THE INVENTION

The present invention has been made in view of the above-described circumstances, and an object thereof is to provide a circuit protection unit and a conductive module capable of properly protecting connection portions between a circuit protection component and a pair of terminal fittings.

In order to achieve the above mentioned object, a circuit protection unit according to one aspect of the present invention includes a circuit protection component that fuses a fusible portion when overcurrent flows between a first electric connection target and a second electric connection target; a first terminal fitting including a first electric connection portion electrically connected to a first electrode of the circuit protection component and electrically connected to the first electric connection target; a second terminal fitting including a second electric connection portion electrically connected to a second electrode of the circuit protection component and electrically connected to the second electric connection target; and a housing component that has insulation property and internally houses the first electric connection portion, the second electric connection portion, and the circuit protection component installed across the first electric connection portion and the second electric connection portion, wherein the housing component includes a bottom wall portion on which the first electric connection portion and the second electric connection portion are placed; a plurality of side wall portions protruding from the bottom wall portion in a plate thickness direction of the bottom wall portion and provided at positions surrounding the first electric connection portion, the second electric connection portion, and the circuit protection component as viewed from the plate thickness direction; and a side wall opening opened toward a direction intersecting with the plate thickness direction.

In order to achieve the above mentioned object, a conductive module according to another aspect of the present invention includes a connection conductor electrically connected to an electrode terminal of a battery cell constituting a battery module; and a circuit protection unit that electrically connects the connection conductor to a battery monitoring unit that monitors a battery state of the battery cell, wherein the circuit protection unit includes a circuit protection component that fuses a fusible portion when overcurrent flows between the connection conductor and the battery monitoring unit; a first terminal fitting including a first electric connection portion electrically connected to a first electrode of the circuit protection component and electrically connected to the connection conductor; a second terminal fitting including a second electric connection portion electrically connected to a second electrode of the circuit protection component and electrically connected to the battery monitoring unit; a wiring component interposed between the second terminal fitting and the battery monitoring unit; and a housing component that has insulation property and internally houses the first electric connection portion, the second electric connection portion, and the circuit protection component installed across the first electric connection portion and the second electric connection portion, the wiring component includes a conductor portion electrically connected to the second terminal fitting at one end and electrically connected to the battery monitoring unit at another end, and the housing component includes: a bottom wall portion on which the first electric connection portion and the second electric connection portion are placed; a plurality of side wall portions protruding from the bottom wall portion in a plate thickness direction of the bottom wall portion and provided at positions surrounding the first electric connection portion, the second electric connection portion, and the circuit protection component as viewed from the plate thickness direction; and a side wall opening opened toward a direction intersecting with the plate thickness direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating schematic configurations of a circuit protection unit and a conductive module according to a first embodiment;

FIG. 2 is a schematic view illustrating schematic configurations of a battery module and connection conductors that electrically connect electrode terminals of battery cells constituting the battery module with each other;

FIG. 3 is a perspective view illustrating a schematic configuration of the circuit protection unit according to the first embodiment;

FIG. 4 is an exploded perspective view illustrating the schematic configuration of the circuit protection unit according to the first embodiment;

FIG. 5 is a plan view illustrating a coating resin portion provided in the circuit protection unit according to the first embodiment;

FIG. 6 is an exploded perspective view illustrating a schematic configuration of a circuit protection unit according to a second embodiment; and

FIG. 7 is a perspective view illustrating a schematic configuration of a circuit protection unit according to a third embodiment.

### DETAILED DESCRIPTION OF THE PREFERRED EMBODIMENTS

Embodiments according to the present invention will be described in detail below with reference to the drawings. Note that the invention is not limited by the embodiments. Furthermore, components in the above-described embodiments include those that can be easily replaced by a skilled person and those that are substantially the same.

### First Embodiment

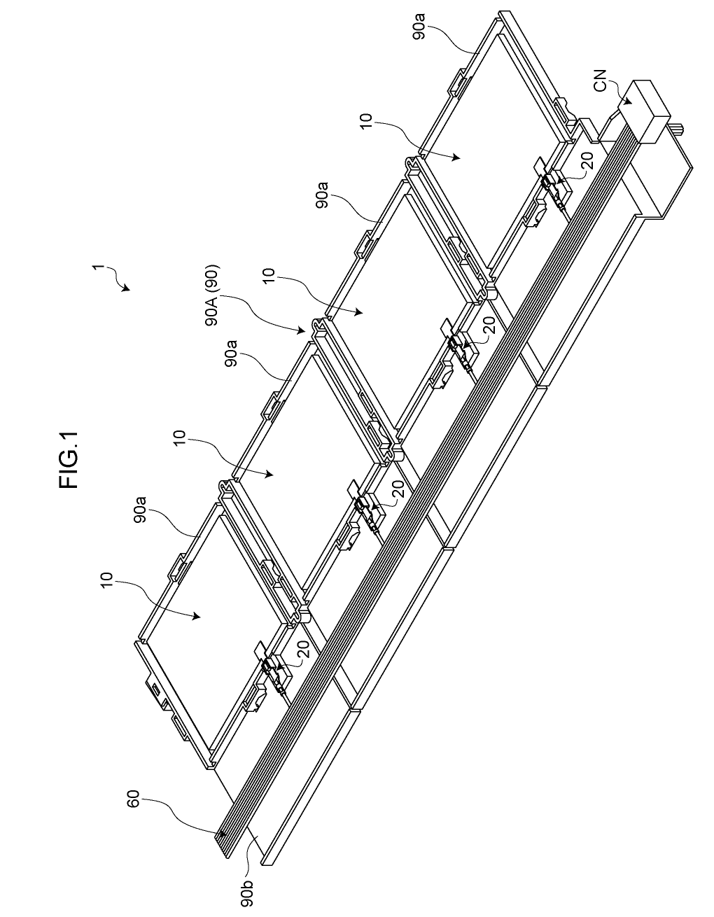

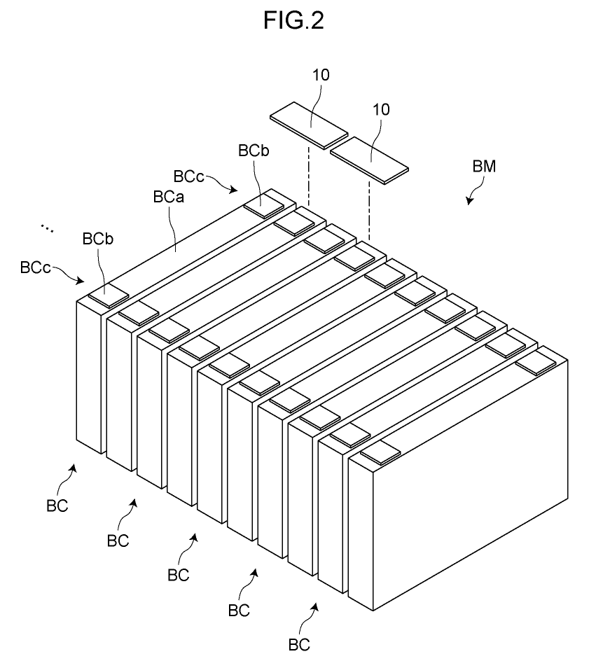

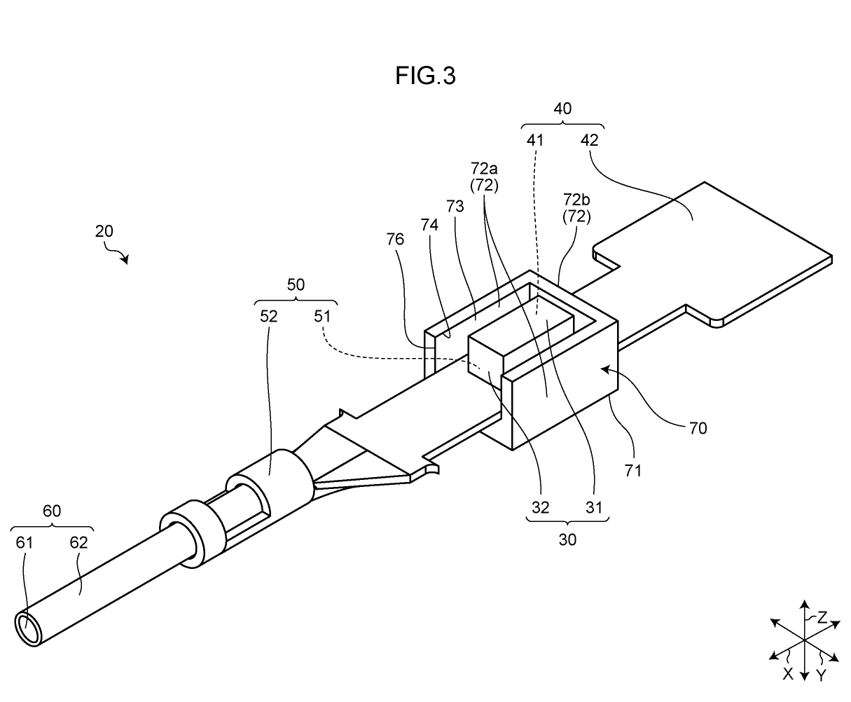

A conductive module 1 in FIG. 1 is assembled to a battery module BM (see FIG. 2) in which a plurality of battery cells BC is aligned, and electrically connects the battery module BM with a battery monitoring unit (not illustrated). The conductive module 1 thereby causes the battery monitoring unit to monitor the battery states of the battery cells BC. Furthermore, a battery pack including the conductive module 1 and the battery module BM as described above is mounted on a vehicle (e.g., battery electric vehicle (BEV) and hybrid electric vehicle (HEV)) including a rotary machine serving as a drive source, and supplies power to the rotary machine. Furthermore, a circuit protection unit 20 (see FIGS. 1 and 3) to be applied to the conductive module 1 as described above includes a circuit protection component 30, a pair of terminal fittings (first terminal fitting 40 and second terminal fitting 50), and a housing component 70. Examples of the circuit protection component 30 include a fuse. The pair of terminal fittings are electrically connected to the circuit protection component 30. The housing component 70 houses connection portions between the circuit protection component 30 and the pair of terminal fittings. The circuit protection unit 20 protects the connection portions between the circuit protection component 30 and the pair of terminal fittings with the housing component 70. Then, circuit protection units 20 and the conductive module 1 of the embodiment can properly protect the connection portions between the circuit protection component 30 and the pair of terminal fittings by providing a side wall opening 76 in the housing component 70. Configurations of the circuit protection units 20 and the conductive module 1 will be described in detail below with reference to FIGS. 1 to 5.

Note that, as illustrated in FIG. 2, in a battery cell BC of the embodiment, a cell body BCa has a shape of a rectangular parallelepiped having six outer wall surfaces. Then, the battery cells BC are arranged such that outer wall surfaces thereof face each other. In the battery cell BC, positive and negative electrode terminals BCb are provided on one of the six outer wall surfaces of the cell body BCa. Therefore, in the battery module BM of the embodiment, two electrode terminal groups BCc are provided on one plane along the alignment direction of the battery cells BC. In the electrode terminal groups BCc, a plurality of electrode terminals BCb is arranged.

Furthermore, as illustrated in FIG. 2, the electrode terminals BCb of the embodiment have a flat plate shape. Then, as illustrated in FIG. 2, the electrode terminals BCb are electrically connected to connection conductors 10 to be described later by joining the connection conductors 10 by, for example, laser welding. Note that the electrode terminals BCb may have a shape of an electrode pole including a male screw portion. In this case, the electrode terminals BCb and the connection conductors 10 are electrically connected with each other by screwing female screw members to male screw portions of the electrode terminals BCb and fixing the connection conductors 10 to the electrode terminals BCb with the screws.

Furthermore, for convenience of description, FIGS. 3, 6, and 7 do not illustrate a coating resin portion 80 provided on the circuit protection unit 20.

Furthermore, in the following description, a first direction, a second direction, and a third direction intersect with each other. The first direction is referred to as an "axial direction X". The second direction is referred to as a "width direction Y". The third direction is referred to as a "height direction Z". Here, the axial direction X, the width direction Y, and the height direction Z are orthogonal to each other. Furthermore, the axial direction X typically corresponds to, for example, a direction in which a first electric connection portion 41 of the first terminal fitting 40 is connected with a second electric connection portion 51 of the second terminal fitting 50 and an extending direction of a bottom wall portion 71 of the housing component 70. Furthermore, the width direction Y corresponds to, for example, the width direction of the first electric connection portion 41, the width direction of the second electric connection portion 51, and the width direction of the bottom wall portion 71 of the housing component 70. Furthermore, the height direction Z typically corresponds to, for example, the plate thickness direction of the first electric connection portion 41, the plate thickness direction of the second electric connection portion 51, and the plate thickness direction of the bottom wall portion 71 of the housing component 70.

As illustrated in FIG. 1 and the like, the conductive module 1 includes the connection conductors 10 and circuit protection units 20. The connection conductors 10 are electrically connected to the electrode terminals BCb of the battery cells BC constituting the battery module BM. The circuit protection units 20 electrically connect the connection conductors 10 to the battery monitoring unit (not illustrated) that monitors the battery states of the battery cells BC.

The connection conductors 10 are conductive components formed of conductive material such as metal. The connection conductors 10 in the embodiment are metallic plate-shaped conductive components called bus bars. For example, a metal plate is pressed in accordance with shapes of respective parts to integrally form the parts. As illustrated in FIGS. 1 and 2, the connection conductors 10 have a rectangular flat plate shape, and are joined to electrode terminals BCb of adjacent battery cells BC to electrically connect the battery cells BC with each other.

As illustrated in FIGS. 3 to 5, the circuit protection unit 20 includes the circuit protection component 30, the first terminal fitting 40, the second terminal fitting 50, and a wiring component 60. The circuit protection component 30 fuses a fusible portion when overcurrent flows between a connection conductor 10 serving as a first electric connection target and the battery monitoring unit serving as a second electric connection target. The first terminal fitting 40 and the second terminal fitting 50 are electrically connected to the circuit protection component 30. The wiring component 60 is interposed between the second terminal fitting 50 and the battery monitoring unit. Furthermore, as illustrated in FIGS. 3 to 5, the circuit protection unit 20 further includes the housing component 70 and the coating resin portion 80. The housing component 70 internally houses the first electric connection portion 41 of the first terminal fitting 40, the second electric connection portion 51 of the second terminal fitting 50, and the circuit protection component 30 installed across the first electric connection portion 41 and the second electric connection portion 51. The coating resin portion 80 fills the housing component 70, and wraps the circuit protection component 30, the first electric connection portion 41, and the second electric connection portion 51.

When overcurrent flows through an electric circuit, the circuit protection component 30 fuses and interrupts the circuit to protect an electric device. The circuit protection component 30 in the embodiment is a rectangular parallelepiped-shaped chip fuse including a fusible portion. As illustrated in FIGS. 3 to 5, the circuit protection component 30 includes a first electrode 31 and a second electrode 32. The first electrode 31 is electrically connected to the first terminal fitting 40 arranged on the side of the connection conductor 10. The second electrode 32 is electrically connected to the second terminal fitting 50 arranged on the side of the battery monitoring unit.

The first electrode 31 is provided on one end side in the axial direction X of the circuit protection component 30. The second electrode 32 is provided on the other end side in the axial direction X of the circuit protection component 30, that is, on the opposite side of the first electrode 31 in the axial direction X. In the circuit protection component 30 of the embodiment, the first electrode 31 and the second electrode 32 are linearly arranged along the axial direction X. The first electrode 31 is electrically connected to the first terminal fitting 40. The second electrode 32 is electrically connected to the second terminal fitting 50. The first terminal fitting 40 and the second terminal fitting 50 can be linearly connected to each other along the axial direction X.

Note that, as illustrated above, the circuit protection component 30 may be configured as a chip fuse including a fusible portion, or may be configured as a pattern fuse in which a wiring pattern including a fusible portion is provided on a printed circuit board (e.g., flexible printed circuit board).

The first terminal fitting 40 is a conductive component formed of conductive material such as metal. The first terminal fitting 40 in the embodiment is a metallic plate-shaped component. For example, a metal plate is pressed in accordance with shapes of respective parts to integrally form the parts. As illustrated in FIGS. 3 to 5, the first terminal fitting 40 includes the first electric connection portion 41 and a first electric connection target connection portion. The first electric connection portion 41 is electrically connected to the first electrode 31 of the circuit protection component 30. The first electric connection target connection portion is electrically connected to the first electric connection target. Note that, in the embodiment, the first electric connection target connection portion will be referred to and described as a conductor connection portion 42.

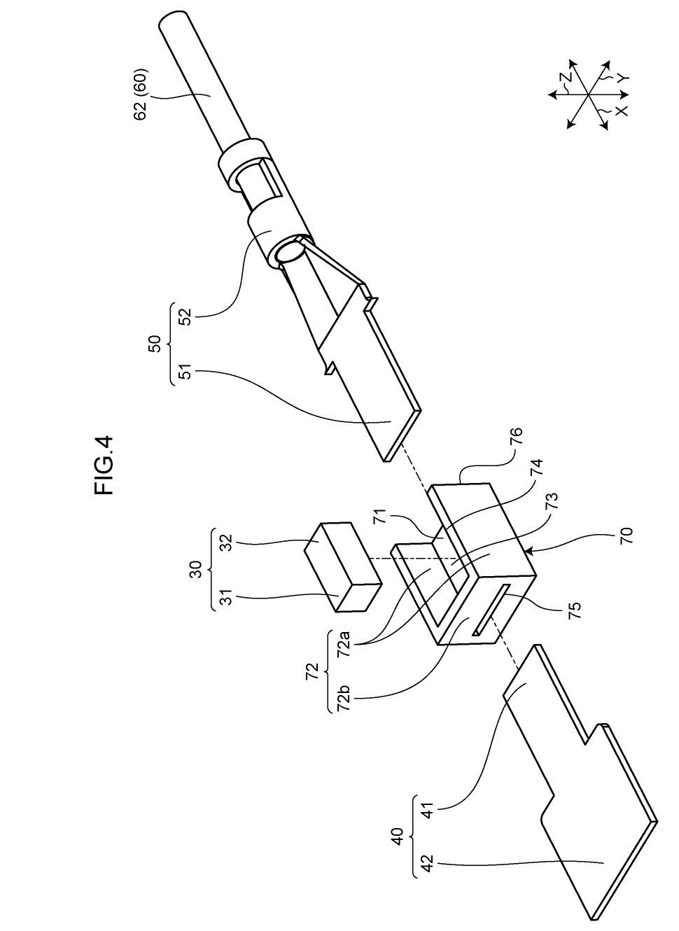

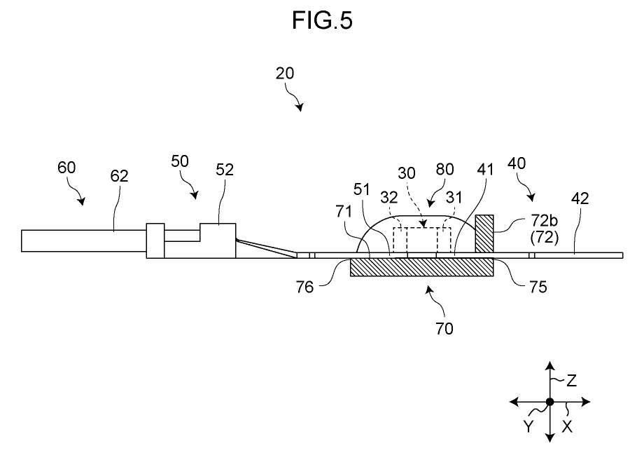

As illustrated in FIG. 4, the first electric connection portion 41 has a rectangular flat plate shape. Furthermore, the width (length in width direction Y) of the first electric connection portion 41 is set to have a length insertable into an insertion hole 75 of the housing component 70 to be described later. In the embodiment, the first electric connection portion 41 has a width narrower than the width (length in width direction Y) of the conductor connection portion 42 and equal to the width (length in width direction Y) of the insertion hole 75. Therefore, the first electric connection portion 41 can be positioned with respect to the housing component 70 by being inserted into the insertion hole 75 of the housing component 70. Furthermore, as illustrated in FIGS. 3 and 5, the first electric connection portion 41 is inserted into the insertion hole 75 of the housing component 70, and the first electrode 31 of the circuit protection component 30 is placed on the surface of the first electric connection portion 41 with the first electric connection portion 41 being housed in the housing component 70. The first electrode 31 is then joined by laser welding, soldering, or the like. The first electric connection portion 41 is thereby electrically connected to the circuit protection component 30.

As illustrated in FIGS. 3 and 4, the conductor connection portion 42 has a rectangular flat plate shape. Therefore, the conductor connection portion 42 is placed on the connection conductor 10 such that flat surfaces overlap each other. The connection conductor 10 is joined by laser welding, ultrasonic joining, or the like. The conductor connection portion 42 is thereby electrically connected to the connection conductor 10, which is the first electric connection target. Furthermore, as illustrated in FIGS. 3 and 4, the first electric connection portion 41 and the conductor connection portion 42 described above are adjacent to each other, so that the first terminal fitting 40 has a flat plate shape as a whole.

The second terminal fitting 50 is a conductive component formed of conductive material such as metal. The second terminal fitting 50 in the embodiment is a component three-dimensionally formed of a metallic plate-shaped material. For example, a metal plate is pressed in accordance with shapes of respective parts to integrally form the parts. As illustrated in FIGS. 3 to 5, the second terminal fitting 50 includes the second electric connection portion 51 and a second electric connection target connection portion. The second electric connection portion 51 is electrically connected to the second electrode 32 of the circuit protection component 30. The second electric connection target connection portion is electrically connected to the second electric connection target. Note that, in the embodiment, the second electric connection target connection portion will be referred to and described as a wiring connection portion 52.

As illustrated in FIG. 4, the second electric connection portion 51 has a rectangular flat plate shape. Furthermore, the width (length in width direction Y) of the second electric connection portion 51 is set to have a length insertable into the side wall opening 76 of the housing component 70 to be described later. In the embodiment, the second electric connection portion 51 has a width equal to the width (length in width direction Y) of the side wall opening 76. Therefore, the second electric connection portion 51 can be positioned with respect to the housing component 70 by being inserted into the side wall opening 76 of the housing component 70. Furthermore, as illustrated in FIGS. 3 and 5, the second electrode 32 of the circuit protection component 30 is placed on the surface of the second electric connection portion 51 with the second electric connection portion 51 being housed inside the housing component 70. The second electrode 32 is then joined by laser welding, soldering, or the like. The second electric connection portion 51 is thereby electrically connected to the circuit protection component 30.

As illustrated in FIGS. 3 and 4, the wiring connection portion 52 has a cylindrical shape. A conductor portion 61 of the wiring component 60 to be described later is bonded with pressure to the wiring connection portion 52. The wiring connection portion 52 is thereby electrically connected to the wiring component 60, which is the second electric connection target. Furthermore, as illustrated in FIGS. 3 and 4, the second electric connection portion 51 and the wiring connection portion 52 described above are adjacent to each other, so that the second terminal fitting 50 can pull out the wiring component 60 along a direction in which the second electric connection portion 51 and the wiring connection portion 52 are adjacent to each other, that is, the axial direction X, which is the extending directions of the second electric connection portion 51 and the wiring connection portion 52. Note that the wiring connection portion 52 may have a cylindrical shape as illustrated in FIG. 3 and the like, or may include a pair of barrel pieces.

As illustrated in FIG. 3, the wiring component 60 is an insulated wire including the conductor portion 61 (core wire) and an insulating coating portion 62. The conductor portion 61 has conductivity. The conductor portion 61 is electrically connected to the second terminal fitting 50 at one end, and is electrically connected to the battery monitoring unit at the other end. The insulating coating portion 62 has insulation property. The insulating coating portion 62 coats the conductor portion 61. The conductor portion 61 here includes a plurality of conductive element wires. Furthermore, the insulating coating portion 62 is formed by extruding, for example, insulating resin material (appropriately selected in consideration of wear resistance, chemical resistance, heat resistance, and like, such as PP, PVC, and cross-linked PE). Note that the conductor portion 61 may be obtained by twisting a plurality of element wires 11a or bundling the plurality of element wires 11a.

Furthermore, as illustrated in FIG. 3, the wiring component 60 linearly extends in the axial direction X. The conductor portion 61 has a substantially circular cross-sectional shape (cross-sectional shape in direction intersecting with axial direction X, which is extending direction of wiring component 60). The insulating coating portion 62 has a substantially annular cross-sectional shape. As a whole, the wiring component 60 has a substantially circular cross-sectional shape. Furthermore, in at least one end of the wiring component 60, a conductor exposed portion is bonded with pressure to the wiring connection portion 52 of the second terminal fitting 50. The wiring connection portion 52 is thereby electrically connected to one end of the conductor portion 61. The conductor exposed portion is obtained by removing the insulating coating portion 62 and exposing the conductor portion 61 from the end of the insulating coating portion 62. Note that the wiring component 60 may be a flat wiring menber such as a flexible printed circuit board in which the conductor portion 61 is formed as a wiring pattern.

The housing component 70 is formed of insulating material such as synthetic resin. The housing component 70 protects the connection portions between the circuit protection component 30 and the pair of terminal fittings (first terminal fitting 40 and second terminal fitting 50), which are housed inside. The connection portions include: the portion in which the first electrode 31 of the circuit protection component 30 and the first electric connection portion 41 of the first terminal fitting 40 are connected with each other; and the portion in which the second electrode 32 of the circuit protection component 30 and the second electric connection portion 51 of the second terminal fitting 50 are connected with each other. As illustrated in FIGS. 3 and 4, the housing component 70 of the embodiment includes the bottom wall portion 71 and a plurality of side wall portions 72 protruding from the bottom wall portion 71 in the height direction Z.

As illustrated in FIGS. 3 and 4, the bottom wall portion 71 extends along the axial direction X and the width direction Y, and has a plate shape with the height direction Z as a plate thickness direction. The bottom wall portion 71 of the embodiment has a rectangular flat plate shape, and is provided with an installation surface 71a on which the first electric connection portion 41 of the first terminal fitting 40 and the second electric connection portion 51 of the second terminal fitting 50 are to be placed. Therefore, in the housing component 70 of the embodiment, the circuit protection component 30 is placed on the first electric connection portion 41 of the first terminal fitting 40 and the second electric connection portion 51 of the second terminal fitting 50, which have been placed on the installation surface 71a. A portion in which the first electrode 31 of the circuit protection component 30 and the first electric connection portion 41 of the first terminal fitting 40 are connected with each other and a portion in which the second electrode 32 of the circuit protection component 30 and the second electric connection portion 51 of the second terminal fitting 50 are connected with each other can be placed on the bottom wall portion 71.

The side wall portions 72 have a plate shape with the axial direction X or the width direction Y as a plate thickness direction. As illustrated in FIGS. 3 and 4, the side wall portions 72 of the embodiment include a pair of first side wall portions 72a and a second side wall portion 72b. The pair of first side wall portions 72a protrude from both ends in the width direction Y of the bottom wall portion 71. The second side wall portion 72b protrudes from one end in the axial direction X of the bottom wall portion 71, and couples the first side wall portions 72a with each other.

As illustrated in FIGS. 3 and 4, the pair of first side wall portions 72a extend along the axial direction X and the height direction Z, and have a plate shape with the width direction Y as a plate thickness direction. The first side wall portions 72a of the embodiment have a rectangular flat plate shape. Furthermore, the pair of first side wall portions 72a have a length along the axial direction X and a length along the height direction Z, which are equal to each other. Furthermore, the bottom wall portion 71 protrudes from ends on the lower side in the height direction Z along the width direction Y to form the pair of first side wall portions 72a. Furthermore, the pair of first side wall portions 72a extend from one end to the other end in the axial direction X of the bottom wall portion 71. Therefore, the pair of first side wall portions 72a of the embodiment are provided at edge portions of the bottom wall portion 71 having a rectangular shape, that is, at positions surrounding the first electric connection portion 41, the second electric connection portion 51, and the circuit protection component 30, which are placed on the bottom wall portion 71, as viewed from the height direction Z.

As illustrated in FIGS. 3 and 4, the second side wall portion 72b extends along the width direction Y and the height direction Z, and has a plate shape with the axial direction X as a plate thickness direction. The second side wall portion 72b of the embodiment has a rectangular flat plate shape. Furthermore, the second side wall portion 72b has a length along the height direction Z equal to the length along the height direction Z of the first side wall portions 72a. Furthermore, the second side wall portion 72b extends from one end to the other end in the width direction Y of the bottom wall portion 71. Furthermore, as illustrated in FIGS. 3 and 4, the second side wall portion 72b is provided at an end on the side where the first terminal fitting 40 is located among both ends in the axial direction X of the bottom wall portion 71. Therefore, similarly to the above-described first side wall portions 72a, the second side wall portion 72b of the embodiment is provided at an edge portion of the bottom wall portion 71 having a rectangular shape, that is, at a position surrounding the first electric connection portion 41, the second electric connection portion 51, and the circuit protection component 30, which are placed on the bottom wall portion 71, as viewed from the height direction Z. Furthermore, as illustrated in FIGS. 3 and 4, the pair of first side wall portions 72a and the second side wall portion 72b described above are integrated, so that the side wall portions 72 have a U shape as viewed from the height direction Z. Therefore, the housing component 70 of the embodiment can surround, from three directions, the first electric connection portion 41, the second electric connection portion 51, and the circuit protection component 30, which are placed on the bottom wall portion 71, with the pair of first side wall portions 72a and the second side wall portion 72b (see FIG. 3).

Furthermore, as illustrated in FIG. 4, the housing component 70 includes a housing space portion 73, a top surface opening 74, and the insertion hole 75. The housing space portion 73 serves as internal space. The top surface opening 74 is opened toward the height direction Z. The insertion hole 75 is opened toward the axial direction X. The housing space portion 73 here is partitioned off by the bottom wall portion 71 and the pair of side wall portions 72. Furthermore, the top surface opening 74 is partitioned off by the pair of side wall portions 72, and is sandwiched between ends located on a side opposite to the side where the bottom wall portion 71 is located in the height direction Z. Furthermore, the insertion hole 75 is provided at a lower end in the height direction Z of the second side wall portion 72b, and is used to insert the first electric connection portion 41 of the first terminal fitting 40 into the housing component 70. The insertion hole 75 has a rectangular shape in accordance with the cross-sectional shape of the first electric connection portion 41 (cross-sectional shape in direction intersecting with axial direction X, which is extending direction of first electric connection portion 41), and has a size in which the first electric connection portion 41 can be inserted.

Furthermore, as illustrated in FIGS. 3 and 4, the housing component 70 has the side wall opening 76 opened toward the axial direction X. The side wall opening 76 is partitioned off by the bottom wall portion 71 and the pair of side wall portions 72, and is surrounded, from three directions, by the end in the axial direction X of the bottom wall portion 71 and the ends in the axial direction X of the pair of side wall portions 72. Furthermore, as illustrated in FIGS. 3 and 4, the side wall opening 76 is provided at an end on a side where the second terminal fitting 50 is located among both ends in the axial direction X of the bottom wall portion 71. Thus, the side wall opening 76 is provided at a position facing the second side wall portion 72b in the axial direction X. Therefore, similarly to the above-described side wall portions 72, the side wall opening 76 of the embodiment is provided at an edge portion of the bottom wall portion 71 having a rectangular shape, that is, at a position surrounding the first electric connection portion 41, the second electric connection portion 51, and the circuit protection component 30, which are placed on the bottom wall portion 71, as viewed from the height direction Z. Thus, the circuit protection unit 20 of the embodiment can protect connection portions between the circuit protection component 30 and the pair of terminal fittings (first terminal fitting 40 and second terminal fitting 50), which are housed inside the housing component 70, by providing the side wall portions 72 on three of four sides of the bottom wall portion 71 of the housing component 70 having a rectangular shape while inhibiting heat generated in the connection portions between the circuit protection component 30 and the pair of terminal fittings from accumulating inside the housing component 70 by providing the side wall opening 76 on a remaining side where no side wall portion 72 is provided. The side wall opening 76 causes the inside and the outside of the housing component 70 to communicate with each other.

Note that, although having been described above as being provided at an end on the side where the first terminal fitting 40 is located among both ends in the axial direction X of the bottom wall portion 71, the second side wall portion 72b and the insertion hole 75 provided below the second side wall portion 72b may be provided at an end on a side, where the second terminal fitting 50 is located, opposite to the first terminal fitting 40. Furthermore, in that case, the side wall opening 76 may be provided at an end on the side where the first terminal fitting 40 is located among both ends in the axial direction X of the bottom wall portion 71.

The coating resin portion 80 wraps the circuit protection component 30, the first electric connection portion 41, and the second electric connection portion 51 to inhibit energization between the first electric connection portion 41 and the second electric connection portion 51. Furthermore, the coating resin portion 80 can function as a fixing member that fixes the first electric connection portion 41, the second electric connection portion 51, and the circuit protection component 30 inside the housing component 70 by being stuck to the bottom wall portion 71 of the housing component 70. Examples of the coating resin portion 80 include solidified material obtained by curing liquid resin material (so-called potting material) dropped so as to wrap the circuit protection component 30, the first electric connection portion 41, and the second electric connection portion 51. Note that resin material having a viscosity at which the resin material can remain inside the housing component 70 during a period from filling of the housing component 70 to curing is desirably used as a resin material that forms the coating resin portion 80.

Note that, since provided at a position facing the insertion hole 75 in the axial direction X, the above-described side wall opening 76 can function as an insertion port for inserting the second electric connection portion 51 of the second terminal fitting 50 into the housing component 70, and can function as a heat discharge port for inhibiting heat generated in the connection portions between the circuit protection component 30 and the pair of terminal fittings (first terminal fitting 40 and second terminal fitting 50) from accumulating inside the housing component 70. In addition, the side wall opening 76 can function as a supply hole for supplying liquid resin material into the housing component 70 and an air vent port for releasing gas inside the housing component 70 to the outside of the housing component 70 at the time of supplying liquid resin material into the housing component 70. Therefore, the circuit protection unit 20 of the embodiment can improve the degree of freedom in manufacturing as compared to conventional circuit protection units while protecting connection portions between the circuit protection component 30 and the pair of terminal fittings more appropriately by providing the side wall opening 76 on a side surface of the housing component 70.

Furthermore, in addition to the connection conductors 10 and the circuit protection units 20, the above-described conductive module 1 further includes a housing component (hereinafter referred to as "module housing component") 90 that has insulation property and that houses the circuit protection unit 20 (see FIG. 1). As illustrated in FIG. 1, the module housing component 90 includes housing chambers (hereinafter, referred to as "conductor housing chambers") 90a that house the connection conductors 10 and housing chambers (hereinafter, referred to as "unit housing chambers") 90b that house the circuit protection units 20. Furthermore, the conductor housing chambers 90a are provided for the connection conductors 10 connected to the plurality of electrode terminals BCb constituting the electrode terminal groups BCc. Furthermore, when wiring components 60 of the circuit protection units 20 include electric wires, the electric wires provided for each of the circuit protection units 20 are routed to the side of the battery monitoring unit in the unit housing chamber 90b. Then, ends of the wiring components 60 routed to the side of the battery monitoring unit are connected to a connector CN. Therefore, the wiring components 60 are electrically connected to the battery monitoring unit via the connector CN. Note that, when the wiring components 60 are flat wiring members, the unit housing chambers 90b house the flat wiring members including conductor portions connected to second terminal fittings 50 of the plurality of circuit protection units 20 (not illustrated).

Furthermore, the module housing component 90 includes a first housing member (hereinafter, referred to as "first module housing member") 90A (see FIG. 1) and a second housing member (hereinafter, referred to as "second module housing member") (not illustrated). The first housing member 90A and the second housing member are assembled and fixed to each other, and internally form a plurality of conductor housing chambers 90a and a plurality of unit housing chambers 90b. Note that the first module housing member 90A and the second module housing member here are formed of insulating material, such as synthetic resin. Furthermore, the first module housing member 90A is provided with space portions for forming the plurality of conductor housing chambers 90a and the plurality of unit housing chambers 90b at positions of completion of assembling with the second module housing member. Then, the second module housing member serves as a cover member that covers openings of the space portions.

The above-described conductive module 1 includes the connection conductors 10 and the circuit protection units 20. The connection conductors 10 are electrically connected to the electrode terminals BCb of the battery cells BC constituting the battery module BM. The circuit protection units 20 electrically connect the connection conductors 10 to the battery monitoring unit that monitors the battery states of the battery cells BC. Furthermore, the circuit protection unit 20 includes: a circuit protection component 30 that fuses a fusible portion when overcurrent flows between the connection conductor 10 and the battery monitoring unit; the first terminal fitting 40 including the first electric connection portion 41 electrically connected to the first electrode 31 of the circuit protection component 30 and electrically connected to the connection conductor; a second terminal fitting 50 including the second electric connection portion 51 electrically connected to the second electrode 32 of the circuit protection component 30 and electrically connected to the battery monitoring unit; the wiring component 60 interposed between the second terminal fitting 50 and the battery monitoring unit; and the housing component 70 that has insulation property and internally houses the first electric connection portion 41, the second electric connection portion 51, and the circuit protection component 30 installed across the first electric connection portion 41 and the second electric connection portion 51. The wiring component 60 includes the conductor portion 61 electrically connected to the second terminal fitting 50 at one end and electrically connected to the battery monitoring unit at the other end. Furthermore, the housing component 70 includes: the bottom wall portion 71 on which the first electric connection portion 41 and the second electric connection portion 51 are placed; a plurality of side wall portions 72 protruding from the bottom wall portion 71 in a plate thickness direction (height direction Z) of the bottom wall portion 71 and provided at positions surrounding the first electric connection portion 41, the second electric connection portion 51, and the circuit protection component 30 as viewed from the height direction Z; and the side wall opening 76 opened toward a direction intersecting with the height direction Z.

According to such a configuration, the circuit protection units 20 and the conductive module 1 can save material of a housing component by providing the side wall opening 76 opened toward a direction different from the height direction Z, which is the plate thickness direction of the bottom wall portion 71, in the housing component 70 as compared to a conventional circuit protection unit in which a frame-shaped housing component surrounds, from four directions, connection portions between a circuit protection component and a pair of terminal fittings. Furthermore, the circuit protection units 20 and the conductive module 1 can discharge heat generated in the connection portions between the circuit protection component 30 and the pair of terminal fittings (first terminal fitting 40 and second terminal fitting 50) via the side wall opening 76, so that heat can be inhibited from accumulating inside the housing component 70. Therefore, the circuit protection units 20 and the conductive module 1 of the embodiment can properly protect the connection portions between the circuit protection component 30 and the pair of terminal fittings.

Moreover, the above-described side wall opening 76 is opened toward the axial direction X connecting the first electric connection portion 41 and the second electric connection portion 51 with each other. According to such a configuration, the circuit protection units 20 and the conductive module 1 can cause the side wall opening 76 to function as an insertion port for inserting an end of the first terminal fitting 40 or an end of the second terminal fitting 50 into the housing component 70 while further saving material of the housing component 70 as compared to a conventional circuit protection unit in which a frame-shaped housing component surrounds, from four directions, connection portions between a circuit protection component and a pair of terminal fittings. Furthermore, the circuit protection units 20 and the conductive module 1 can more efficiently discharge heat generated in the connection portions between the circuit protection component 30 and the pair of terminal fittings (first terminal fitting 40 and second terminal fitting 50) via the side wall opening 76, so that heat can be further inhibited from accumulating inside the housing component 70. Therefore, the circuit protection units 20 and the conductive module 1 of the embodiment can properly protect the connection portions between the circuit protection component 30 and the pair of terminal fittings.

Moreover, the above-described side wall portions 72 include the pair of first side wall portions 72a and the second side wall portion 72b. The pair of first side wall portions 72a protrude from both ends in the width direction Y of the bottom wall portion 71. The second side wall portion 72b protrudes from one end in the axial direction X of the bottom wall portion 71, and couples the first side wall portions 72a with each other. The side wall opening 76 is provided at a position facing the second side wall portion 72b in the axial direction X. According to such a configuration, the circuit protection units 20 and the conductive module 1 can cause the side wall opening 76 to function as an insertion port for inserting the end of the first terminal fitting 40 or the end of the second terminal fitting 50 into the housing component 70. Furthermore, the circuit protection units 20 and the conductive module 1 can further save material of the housing component 70 as compared to a conventional circuit protection unit in which a frame-shaped housing component surrounds, from four directions, connection portions between a circuit protection component and a pair of terminal fittings by surrounding, from three directions, the connection portions between the circuit protection component 30 and the pair of terminal fittings (first terminal fitting 40 and second terminal fitting 50) with three wall portions of the pair of first side wall portions 72a and the second side wall portion 72b. Furthermore, the circuit protection units 20 and the conductive module 1 can more efficiently discharge heat generated in the connection portions between the circuit protection component 30 and the pair of terminal fittings via the side wall opening 76, so that heat can be further inhibited from accumulating inside the housing component 70. Therefore, the circuit protection units 20 and the conductive module 1 of the embodiment can properly protect the connection portions between the circuit protection component 30 and the pair of terminal fittings.

Moreover, the above-described circuit protection units 20 further include the coating resin portion 80, which has insulation property, fills the housing component 70, and wraps the circuit protection component 30, the first electric connection portion 41, and the second electric connection portion 51. According to such a configuration, the circuit protection units 20 and the conductive module 1 can inhibit energization between the first electric connection portion 41 and the second electric connection portion 51, and can fix the first electric connection portion 41, the second electric connection portion 51, and the circuit protection component 30 inside the housing component 70 by using the coating resin portion 80. Therefore, the circuit protection units 20 and the conductive module 1 of the embodiment can properly protect the connection portions between the circuit protection component 30 and the pair of terminal fittings.

### Second Embodiment

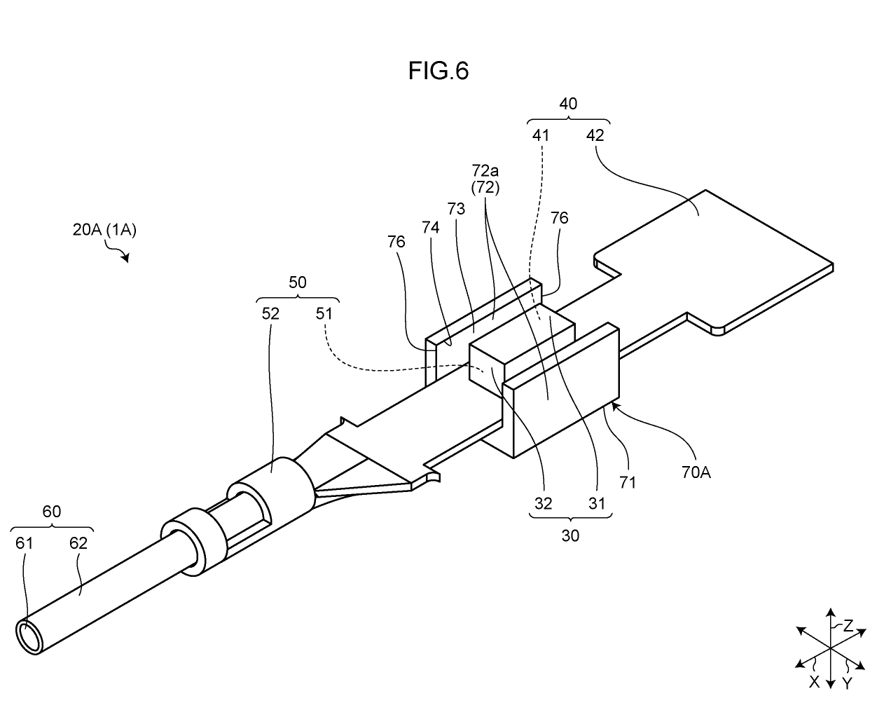

Next, a circuit protection unit 20A and a conductive module 1A according to a second embodiment in FIG. 6 will be described. The circuit protection unit 20A and the conductive module 1A are different from the circuit protection unit 20 and the conductive module 1 described above in the configurations of side wall openings 76 provided in a housing component 70A. Note that, in the second embodiment, the same reference signs are attached to the same components as those in the above-described first embodiment, and detailed description thereof will be omitted.

Specifically, the circuit protection unit 20A to be applied to the conductive module 1A is different from the circuit protection unit 20 in that the side wall portions 72 constituting the housing component 70A include only a pair of first side wall portions 72a protruding from both ends in the width direction Y of the bottom wall portion 71 and a pair of side wall openings 76 are provided in the axial direction X.

As illustrated in FIG. 6, the pair of first side wall portions 72a extend along the axial direction X and the height direction Z, and have a plate shape with the width direction Y as a plate thickness direction. The pair of first side wall portions 72a of the embodiment have a rectangular flat plate shape. Furthermore, as illustrated in FIG. 6, the pair of first side wall portions 72a are provided at both the ends in the width direction Y of the bottom wall portion 71, that is, provided on two of four sides of the bottom wall portion 71 of the housing component 70 having a rectangular shape.

Furthermore, the side wall openings 76 are partitioned off by the bottom wall portion 71 and the pair of side wall portions 72, and are surrounded, from three directions, by the end in the axial direction X of the bottom wall portion 71 and the ends in the axial direction X of the pair of side wall portions 72. Furthermore, as illustrated in FIG. 6, the side wall openings 76 are provided at both the ends in the axial direction X of the bottom wall portion 71, that is, provided on remaining two sides, on which no first side wall portion 72a is provided, among the four sides of the bottom wall portion 71 of the housing component 70 having a rectangular shape. Therefore, according to such a configuration, the circuit protection units 20A and the conductive module 1A can further save material of a housing component by providing the pair of side wall openings 76 opened toward the axial direction X intersecting with the height direction Z, which is the plate thickness direction of the bottom wall portion 71, in the housing component 70A as compared to a conventional circuit protection unit in which a frame-shaped housing component surrounds, from four directions, connection portions between a circuit protection component and a pair of terminal fittings and the above-described circuit protection unit 20. Furthermore, the circuit protection units 20A and the conductive module 1A can discharge heat generated in the connection portions between the circuit protection component 30 and the pair of terminal fittings (first terminal fitting 40 and second terminal fitting 50) via the pair of side wall openings 76, so that heat can be further inhibited from accumulating inside the housing component 70A. Therefore, the circuit protection units 20A and the conductive module 1A of the embodiment can properly protect the connection portions between the circuit protection component 30 and the pair of terminal fittings similarly to the circuit protection unit 20 and the conductive module 1 described above.

### Third Embodiment

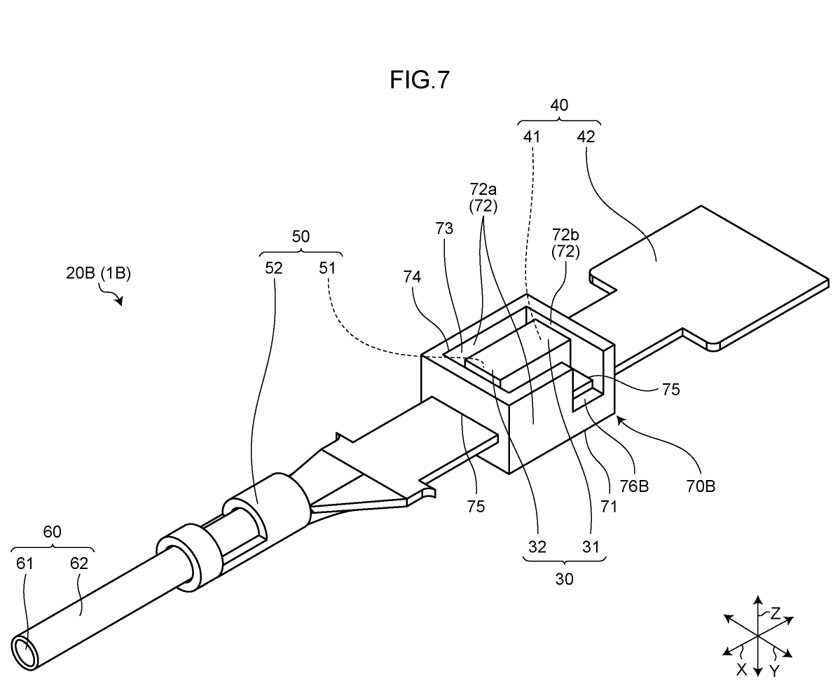

Next, a circuit protection unit 20B and a conductive module 1B according to a third embodiment in FIG. 7 will be described. The circuit protection unit 20B and the conductive module 1B are different from the circuit protection units 20 and 20A and the conductive modules 1 and 1A described above in the configuration of a side wall opening 76B provided in a housing component 70B. Note that, in the third embodiment, the same reference signs are attached to the same components as those in the above-described first and second embodiments, and detailed description thereof will be omitted.

Specifically, the circuit protection unit 20B to be applied to the conductive module 1B is different from the circuit protection units 20 and 20A in that the side wall opening 76B is formed by cutting a part of one side wall portion 72 of the plurality of side wall portions 72.

As illustrated in FIG. 7, the side wall portions 72 include a pair of first side wall portions 72a and a pair of second side wall portions 72b. The pair of first side wall portions 72a protrudes from both ends in the width direction Y of the bottom wall portion 71. The pair of second side wall portions 72b protrudes from both ends in the axial direction X of the bottom wall portion 71, and couples the first side wall portions 72a with each other.

As illustrated in FIG. 7, the pair of first side wall portions 72a extend along the axial direction X and the height direction Z, and have a plate shape with the width direction Y as a plate thickness direction. The first side wall portions 72a of the embodiment have a rectangular flat plate shape. Furthermore, as illustrated in FIG. 7, the pair of first side wall portions 72a are provided at both the ends in the width direction Y of the bottom wall portion 71, that is, provided on two of four sides of the bottom wall portion 71 of the housing component 70 having a rectangular shape.

As illustrated in FIG. 7, the pair of second side wall portions 72b extend along the width direction Y and the height direction Z, and have a plate shape with the axial direction X as a plate thickness direction. The second side wall portion 72b of the embodiment has a rectangular flat plate shape. Furthermore, as illustrated in FIG. 7, the pair of second side wall portions 72b are provided at both the ends in the width direction Y of the bottom wall portion 71, that is, provided on two of four sides of the bottom wall portion 71 of the housing component 70 having a rectangular shape.

Furthermore, the side wall opening 76B is partitioned off by the bottom wall portion 71 and end surfaces of a cut side wall portion 72. Furthermore, as illustrated in FIG. 7, the side wall opening 76B is formed by cutting a part of a first side wall portion 72a, and is thus opened toward the width direction Y, which is a plate thickness direction of the first side wall portion 72a. Therefore, according to such a configuration, the circuit protection units 20B and the conductive module 1B can save material of a housing component by providing the side wall opening 76B opened toward the width direction Y intersecting with the height direction Z, which is the plate thickness direction of the bottom wall portion 71, in the housing component 70B as compared to a conventional circuit protection unit in which a frame-shaped housing component surrounds, from four directions, connection portions between a circuit protection component and a pair of terminal fittings. Furthermore, the circuit protection units 20B and the conductive module 1B can discharge heat generated in the connection portions between the circuit protection component 30 and the pair of terminal fittings (first terminal fitting 40 and second terminal fitting 50) via the side wall opening 76B including a cutout, so that heat can be further inhibited from accumulating inside the housing component 70A. Therefore, the circuit protection units 20B and the conductive module 1B of the embodiment can properly protect the connection portions between the circuit protection component 30 and the pair of terminal fittings similarly to the circuit protection units 20 and 20A and the conductive modules 1 and 1A described above.

Note that the circuit protection units 20, 20A, and 20B and the conductive modules 1, 1A, and 1B according to the above-described embodiments of the present invention are not limited to those in the above-described embodiments. Various modifications thereof can be made in the scope of the claims.

For example, the shapes and positions of the side wall openings 76 and 76B are not particularly limited. Furthermore, the widths (lengths in axial direction X or width direction Y) and heights (length in height direction Z) of the side wall openings 76 and 76B are not particularly limited. The side wall opening may be provided at an end in the width direction Y among the four sides of the bottom wall portion 71 having a rectangular shape, and may be formed by cutting a part of a second side wall portion 72b. Furthermore, the side wall opening may be equal to the heights of the first side wall portions 72a and the heights of the second side wall portions 72b, or may be lower than the heights of the first side wall portions 72a and the heights of the second side wall portions 72b. Furthermore, the side wall opening may be a simple through hole provided in a side wall portion 72.

Furthermore, the number of the side wall openings is not particularly limited. A plurality of side wall openings may be provided in the side wall portions 72.

Furthermore, the housing components 70, 70A, and 70B may be integrated with the first module housing member 90A.

Furthermore, the housing components 70, 70A, and 70B may be assembled to the pair of terminal fittings (first terminal fitting 40 and second terminal fitting 50) and the like, or may be insert-molded into the pair of terminal fittings and the like.

Furthermore, the coating resin portion 80 is not required to be provided inside the housing components 70, 70A, and 70B.

Furthermore, the circuit protection units 20, 20A, and 20B may be applied to, for example, an electric connection box. The circuit protection units 20, 20A, and 20B may be installed at any position on an electric circuit.

Furthermore, the circuit protection units 20, 20A, and 20B and the conductive modules 1, 1A, and 1B according to the embodiment may be configured by appropriately combining the components of the above-described embodiment.

The circuit protection unit and the conductive module according to the present embodiment can have effects of properly protecting connection portions between a circuit protection component and a pair of terminal fittings.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A circuit protection unit comprising:
a circuit protection component that fuses a fusible portion when overcurrent flows between a first electric connection target and a second electric connection target;
a first terminal fitting including a first electric connection portion electrically connected to a first electrode of the circuit protection component and electrically connected to the first electric connection target;
a second terminal fitting including a second electric connection portion electrically connected to a second electrode of the circuit protection component and electrically connected to the second electric connection target; and
a housing component that has insulation property and internally houses the first electric connection portion, the second electric connection portion, and the circuit protection component installed across the first electric connection portion and the second electric connection portion, wherein
the housing component includes:
a bottom wall portion on which the first electric connection portion and the second electric connection portion are placed;
a plurality of side wall portions protruding from the bottom wall portion in a plate thickness direction of the bottom wall portion and provided at positions surrounding the first electric connection portion, the second electric connection portion, and the circuit protection component as viewed from the plate thickness direction; and
a side wall opening opened toward a direction intersecting with the plate thickness direction.

2. The circuit protection unit according to claim 1, wherein
the side wall opening is opened toward an axial direction connecting the first electric connection portion and the second electric connection portion with each other.

3. The circuit protection unit according to claim 2, wherein
the side wall portion includes:
a pair of first side wall portions protruding from both ends in a width direction intersecting with the axial direction of the bottom wall portion; and
a second side wall portion protruding from one end in the axial direction of the bottom wall portion and coupling the first side wall portions with each other; and
the side wall opening is provided at a position facing the second side wall portion in the axial direction.

4. The circuit protection unit according to claim 2, wherein
the side wall portion includes a pair of first side wall portions protruding from both ends in a width direction intersecting with the axial direction of the bottom wall portion, and
a pair of side wall openings are provided in the axial direction.

5. The circuit protection unit according to claim 1, wherein
the side wall opening is formed by cutting a part of one side wall portion of the plurality of side wall portions.

6. The circuit protection unit according to claim 1, further comprising:
a coating resin portion that has insulation property, fills the housing component, and wraps the circuit protection component, the first electric connection portion, and the second electric connection portion.

7. A conductive module comprising:
a connection conductor electrically connected to an electrode terminal of a battery cell constituting a battery module; and
a circuit protection unit that electrically connects the connection conductor to a battery monitoring unit that monitors a battery state of the battery cell, wherein
the circuit protection unit includes:
a circuit protection component that fuses a fusible portion when overcurrent flows between the connection conductor and the battery monitoring unit;
a first terminal fitting including a first electric connection portion electrically connected to a first electrode of the circuit protection component and electrically connected to the connection conductor;
a second terminal fitting including a second electric connection portion electrically connected to a second electrode of the circuit protection component and electrically connected to the battery monitoring unit;
a wiring component interposed between the second terminal fitting and the battery monitoring unit; and
a housing component that has insulation property and internally houses the first electric connection portion, the second electric connection portion, and the circuit protection component installed across the first electric connection portion and the second electric connection portion,
the wiring component includes a conductor portion electrically connected to the second terminal fitting at one end and electrically connected to the battery monitoring unit at another end, and
the housing component includes: a bottom wall portion on which the first electric connection portion and the second electric connection portion are placed; a plurality of side wall portions protruding from the bottom wall portion in a plate thickness direction of the bottom wall portion and provided at positions surrounding the first electric connection portion, the second electric connection portion, and the circuit protection component as viewed from the plate thickness direction; and a side wall opening opened toward a direction intersecting with the plate thickness direction.
